(19) United States
(12) Patent Application Publication
(10) Pub. No.: US 2026/0309307 A1
(43) Pub. Date: Oct. 8, 2026

(54) IN-CABIN IMAGING APPARATUS

(71) Applicant: MITSUBISHI ELECTRIC MOBILITY CORPORATION, Tokyo (JP)

(72) Inventor: Fuqiang HAN, Tokyo (JP)

(73) Assignee: MITSUBISHI ELECTRIC MOBILITY CORPORATION, Tokyo (JP)

(21) Appl. No.: 19/108,335

(22) PCT Filed: Nov. 24, 2022
(86) PCT No.: PCT/JP2022/043324

§ 371 Date: Mar. 3, 2025

(51) Int. Cl. F21V 7/04; B60R 1/29; F21V 14/04; F21V 33/00; G03B 15/03; G03B 30/00

(52) U.S. Cl. CPC F21V 7/048; B60R 1/29; F21V 14/04; F21V 33/0052; G03B 15/03; G03B 30/00

(57) ABSTRACT

An in-cabin imaging apparatus includes: a camera that captures an image in a vehicle cabin; a light emitting element that emits light into the vehicle cabin; a reflector that reflects light from the light emitting element; and a housing that houses the camera, the light emitting element, and the reflector. The reflector is generally tubular and is provided to surround the light emitting element, and an inner surface of the generally tubular reflector is a light reflective surface. The reflector has a cutout in a portion of a side surface thereof.

### TECHNICAL FIELD

The present disclosure relates to an in-cabin imaging apparatus that captures an image in a vehicle cabin.

### BACKGROUND ART

While a driver monitoring system that monitors a state of a driver in a vehicle has been put to practical use, an occupant monitoring system whose monitoring target has been expanded to all occupants in a vehicle cabin has been further developed in recent years. For example, Patent Document 1 below proposes an in-cabin imaging apparatus that captures an image of all seats in a vehicle cabin with a single camera. The in-cabin imaging apparatus that captures the image of all the seats in the vehicle cabin with the single camera can reduce cost and apparatus scale compared with that with a plurality of cameras.

### PRIOR ART DOCUMENTS

### Patent Document

Patent Document 1: Japanese Patent Application Laid-Open No. 2010-253987

### SUMMARY

### Problem to be Solved by the Invention

To capture a sharp video of all seats using an in-cabin imaging apparatus with a single camera, it is necessary to provide an illuminator for each seat or to provide an illuminator that illuminates all the seats for the in-cabin imaging apparatus. The latter is preferable to contribute to reduction in cost and apparatus scale, and an in-cabin imaging apparatus including an illuminator that effectively illuminates a vehicle cabin is desired.

The present disclosure has been conceived to solve a problem as described above, and it is an object of the present disclosure to provide an in-cabin imaging apparatus including an illuminator that effectively illuminates a vehicle cabin.

### Means to Solve the Problem

An in-cabin imaging apparatus according to the present disclosure includes: a camera that captures an image in a vehicle cabin; a light emitting element that emits light into the vehicle cabin; a generally tubular reflector that is provided to surround the light emitting element and has a cutout in a portion of a side surface thereof; and a housing that houses the camera, the light emitting element, and the reflector,

### Effects of the Invention

According to the in-cabin imaging apparatus according to the present disclosure, the generally tubular reflector spreads out light emitted by the light emitting element to an imaging range of the camera, so that an image of all seats can be captured while the vehicle cabin is effectively illuminated.

These and other objects, features, aspects and advantages of the present disclosure will become more apparent from the following detailed description when taken in conjunction with the accompanying drawings.

### BRIEF DESCRIPTION OF DRAWINGS

FIG. 1 is an exploded perspective view illustrating a configuration of an in-cabin imaging apparatus according to Embodiment 1.

FIG. 2 is a perspective view illustrating a configuration of the in-cabin imaging apparatus according to Embodiment 1.

FIG. 3 is a diagram for describing adjustment of a mounting angle of a light emitting element with respect to a camera.

FIG. 4 is a diagram for describing adjustment of an inclination angle of a reflective surface of a reflector relative to the light emitting element.

FIG. 5 is a diagram for describing adjustment of an opening angle of a cutout centered at the light emitting element.

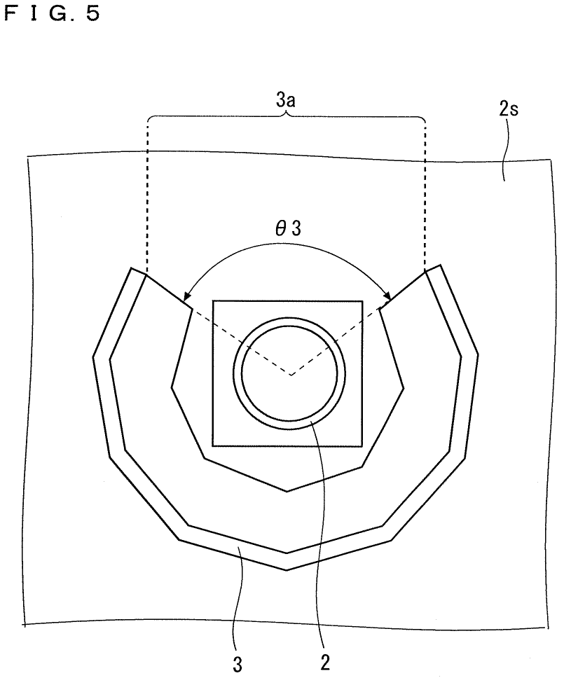

### DESCRIPTION OF EMBODIMENTS

### Embodiment 1

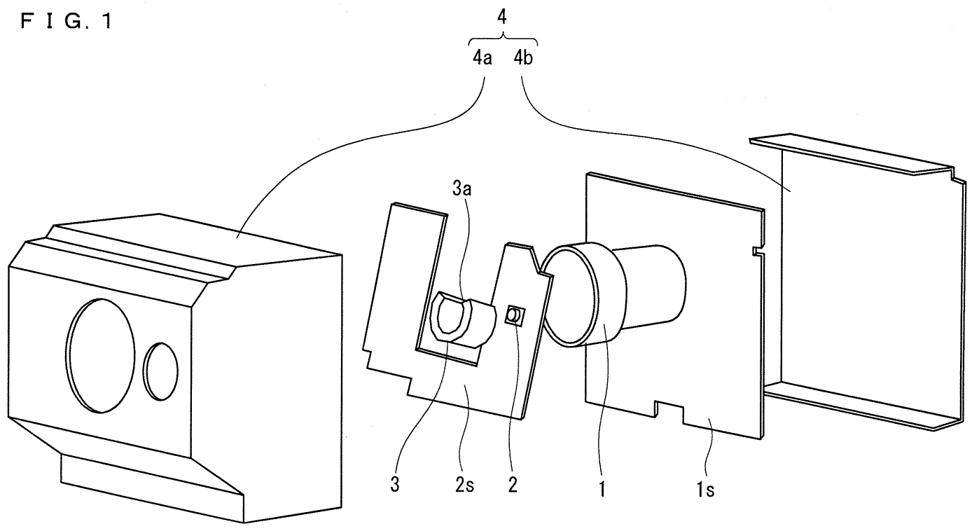

FIG. 1 is an exploded perspective view illustrating a configuration of an in-cabin imaging apparatus according to Embodiment 1. As illustrated in FIG. 1, the in-cabin imaging apparatus according to Embodiment 1 includes a camera 1 that captures an image in a vehicle cabin, a light emitting element 2 that emits light into the vehicle cabin, and a reflector 3 that reflects light from the light emitting element 2. In FIG. 1, only a main configuration of the in-cabin imaging apparatus is illustrated, and a detailed configuration is not illustrated.

The camera 1 is a camera module implemented on a camera substrate 1s. The in-cabin imaging apparatus according to Embodiment 1 is installed at a position from which all seats in the vehicle cabin are overlooked, such as at an overhead console in a vehicle, and the camera 1 has an angle of view wide enough to be able to capture an image of all the seats.

The light emitting element 2 is, for example, an LED implemented on a light emitting element substrate 2s. Light emitted by the light emitting element 2 may be infrared light.

The reflector 3 is generally tubular and is provided to surround the light emitting element 2. An inner surface of the generally tubular reflector 3 is a light reflective surface. The reflector 3 has a cutout 3a in a portion of a side surface thereof. The reflector 3 may be a generally cylindrical reflector having a curved reflective inner surface or may be a generally polygonal tubular reflector having a plurality of reflective inner surfaces.

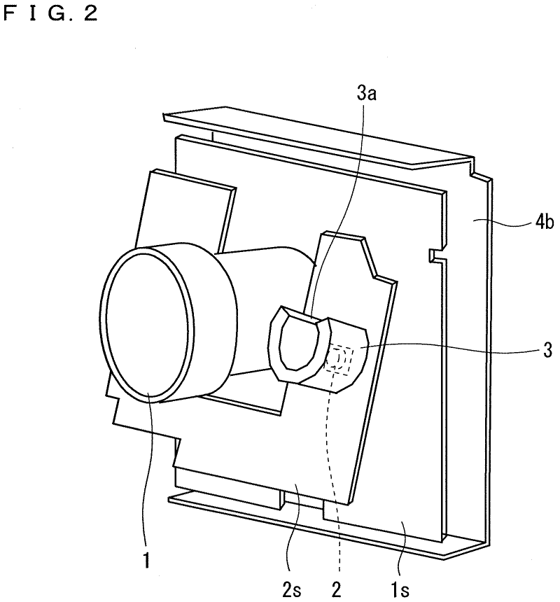

The camera substrate 1s, the light emitting element substrate 2s, and the reflector 3 are housed in a housing 4 including a front cover 4a and a rear cover 4b to constitute the in-cabin imaging apparatus. FIG. 2 is a perspective view of the in-cabin imaging apparatus as assembled. In FIG. 2, however, the front cover 4a is not illustrated.

According to the in-cabin imaging apparatus according to Embodiment 1, the reflector 3 having the cutout 3a reflects part of light emitted by the light emitting element 2 to diffuse the reflected light to an imaging range of the camera 1. Light from the light emitting element 2 thus effectively spreads out in the vehicle cabin, so that the in-cabin imaging apparatus can capture an image of all the seats with the camera 1 while effectively illuminating all the seats and can capture a sharp video of occupants on all the seats. The image of all the seats in the vehicle cabin can be captured with the single camera 1, and there is no need to provide an illuminator for each seat, contributing to reduction in cost and apparatus scale.

Furthermore, the reflector 3 can effectively diffuse light, so that the number of light emitting elements 2 provided in the in-cabin imaging apparatus may be small, also contributing to reduction in cost. While an example in which the in-cabin imaging apparatus includes only one pair of the light emitting element 2 and the reflector 3 is shown in Embodiment 1, a plurality of pairs of light emitting elements 2 and reflectors 3 may be provided.

### Embodiment 2

The in-cabin imaging apparatus is assumed to be installed in vehicles of various vehicle types. A direction of illumination of light emitted by the light emitting element 2 of the in-cabin imaging apparatus is thus preferably adjustable in accordance with a width of the vehicle cabin and a position of each seat.

In Embodiment 2, one or more of (a) a mounting angle of the light emitting element 2 with respect to the camera 1, (b) an inclination angle of the reflective surface of the reflector 3 relative to the light emitting element 2, and (c) an opening angle of the cutout 3a centered at the light emitting element 2 are adjustable to adjust the direction of illumination of light emitted by the light emitting element 2.

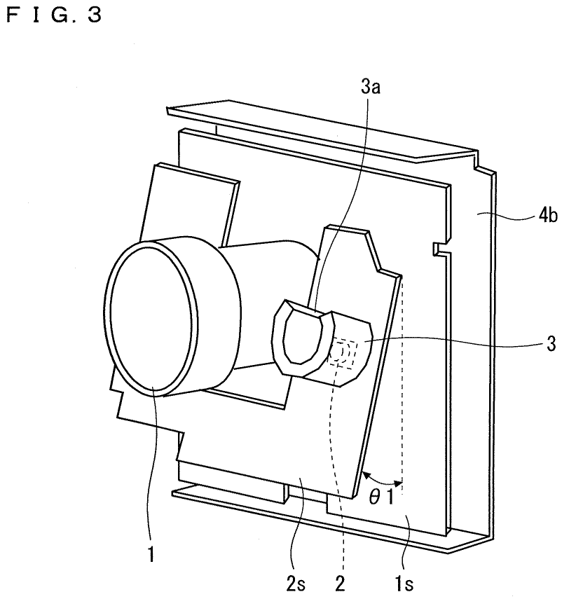

The mounting angle of the light emitting element 2 with respect to the camera 1 corresponds to an angle θ1 formed by the camera substrate 1s and the light emitting element substrate 2s illustrated in FIG. 3. Adjustment of the mounting angle of the light emitting element 2 with respect to the camera 1 can thus be achieved by making a mounting angle of the light emitting element substrate 2s with respect to the camera substrate 1s adjustable.

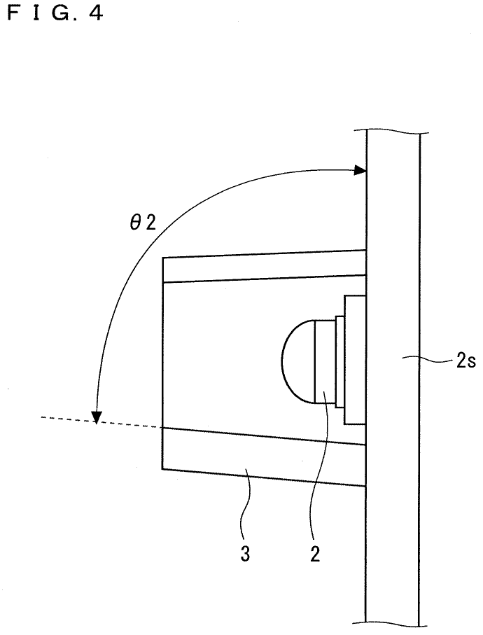

The inclination angle of the reflective surface of the reflector 3 relative to the light emitting element 2 corresponds to an angle θ2 formed by the light emitting element substrate 2s and the inner surface of the reflector 3 illustrated in FIG. 4. Adjustment of the inclination angle of the reflective surface of the reflector 3 relative to the light emitting element 2 can thus be achieved by making a mounting angle of the reflector 3 with respect to the light emitting element substrate 2s adjustable.

The opening angle of the cutout 3a centered at the light emitting element 2 is defined as an angle θ3 formed by two straight lines connecting the light emitting element 2 and opposite ends of the cutout 3a. Adjustment of the opening angle of the cutout 3a centered at the light emitting element 2 can be achieved by making a mounting position of the reflector 3 and a positional relationship between the light emitting element 2 and the reflector 3 adjustable. Alternatively, a width of the cutout 3a may be made adjustable by using a deformable material for the reflector 3.

According to the in-cabin imaging apparatus according to Embodiment 2, the direction of illumination of light emitted by the light emitting element 2 (a direction of reflection of the reflector 3) is adjustable in accordance with the width of the vehicle cabin and the position of each seat to enable application to vehicles of various vehicle types, thereby improving versatility.

Embodiments can freely be combined with each other and can be modified or omitted as appropriate.

The foregoing description is in all aspects illustrative, and it is understood that numerous unillustrated modifications can be devised.

### EXPLANATION OF REFERENCE SIGNS

1 camera, 1s camera substrate, 2 light emitting element, 2s light emitting element substrate, 3 reflector, 3a cutout, 4 housing, 4a front cover, 4b rear cover.

1. An in-cabin imaging apparatus comprising:
a camera that captures an image in a vehicle cabin;
a light emitting element that emits light into the vehicle cabin;
a generally tubular reflector that is provided to surround the light emitting element and has a cutout in a portion of a side surface thereof; and
a housing that houses the camera, the light emitting element, and the reflector.

2. The in-cabin imaging apparatus according to claim 1, wherein
the reflector is a generally polygonal tubular reflector having a plurality of reflective inner surfaces.

3. The in-cabin imaging apparatus according to claim 1, wherein
light emitted by the light emitting element is infrared light.

4. The in-cabin imaging apparatus according to claim 1, wherein
a mounting angle of the light emitting element with respect to the camera is adjustable.

5. The in-cabin imaging apparatus according to claim 1, wherein
an inclination angle of a reflective surface of the reflector relative to the light emitting element is adjustable.

6. The in-cabin imaging apparatus according to claim 1, wherein
an opening angle of the cutout centered at the light emitting element is adjustable.
